(19) United States
(12) Patent Application Publication
(10) Pub. No.: US 2005/0012444 A1
(43) Pub. Date: Jan. 20, 2005

(54) Electron tubes

(76) Inventors: Yoshihisa Yonezawa, Mobara-shi (JP); Yasuhiro Nohara, Mobara-shi (JP); Katsumi Takayama, Mobara-shi (JP)

Correspondence Address: QUARLES & BRADY LLP, 411 E. WISCONSIN AVENUE, SUITE 2040, MILWAUKEE, WI, 53202-4497, US

(21) Appl. No.: 10/890,930

(22) Filed: Jul. 14, 2004

(30) Foreign Application Priority Data
Jul. 16, 2003 (JP) 2003-198051

(51) Int. Cl. H01J 1/62; H01J 63/04

(52) U.S. Cl. 313/495

(57) ABSTRACT

An electron tube, such as a fluorescent display tube, is disclosed. The electron tube includes plural cathode filaments, each of which has the same diameter and a different length. In order to adjust the resistance of each filament, the plural filaments are not serially connected, but effective length of each filament, which contributes to the emission of electrons, is adjusted without serially connecting plural filaments.

### CROSS REFERENCES TO RELATED APPLICATIONS

Not Applicable.

### STATEMENT REGARDING FEDERALLY SPONSORED RESEARCH

Not Applicable.

### BACKGROUND OF THE INVENTION

The present invention relates to electron tubes, such as fluorescent display tubes, flat cathode ray tubes, and others. Particularly, the present invention relates to electron tubes capable of adjusting the length of cathode filaments which contributes to the emission of electrons.

A fluorescent display tube, being one type of conventional electron tube, will be explained by referring to FIGS. 11, 12 and 13. The same numerals are used to designate the common elements in FIGS. 11, 12, and 13. A typical element is designated by the numeral if there are the same constituent elements.

FIG. 11(a) is a cross sectional view illustrating a fluorescent display tube, taken along the line Y2-Y2 of FIG. 11(b) and viewed in the arrow direction. FIG. 11(b) is a plan view (or a cross sectional view) illustrating a fluorescent display tube, taken along the line Y1-Y1 of FIG. 11(a) and viewed in the arrow direction.

A hermetic vessel 61, formed of an insulating material such as glass, includes an anode substrate 611 and a front substrate 612, confronting each other. Metal layers 62 for cathode wiring as well as anode electrodes 66, on which a fluorescent substance is coated, are formed on the anode substrate 611. Each anode electrode 66 is formed of, for example, seven segments arranged in the character 8. The ends of each of cathode filaments 64 are ultrasonic bonded firmly to the metal layers 62, respectively. Spacers 63 sustain the respective filaments in a predetermined height. A grid (for example, a mesh grid) 65 is disposed between the filaments 64 and the anode electrodes 66. A transparent conductive film (Nesa) 68 for electrically shielding is formed over the front substrate 612. Each filament 64, for example, includes a core, for example, made of tungsten or an alloy thereof (for example, rhenium tungsten), on which a carbonate for electron emission is coated.

When the filament 64 is heated with current, it emits thermal electrons. The emitted electrons are controlled by the grid 65 and strike a selected anode electrode 66. As a result, the fluorescent substance on the corresponding anode electrode 66 emits light.

FIG. 12 shows the outline of a driver circuit for the fluorescent display tube.

The filament 64 is heated with the filament power source Ef, supplied from the ac power source (not shown) connected to a transformer T. The heating temperature is normally set to 600° C. to 650° C. The grid driver 72 selectively applies a positive potential of the grid power source Ec to the grid 65. When the positive potential is applied, the filament 64 emits electrons. The anode driver 71 selectively applies the positive potential of the anode power source Eb to the anode electrode 66. When the positive potential is applied, the electrons passing through the grid 65 causes the light emission of the fluorescent substance. Accordingly, the anode electrode 66 glows when positive potentials are applied to the grid 65 and the anode electrode 66, respectively. The anode electrode 66 darkens (or does not glow) when the positive potential is not applied to the grid 65 and/or the anode electrode 66.

As described above, the anode electrode 66 does not glow when the positive potential is not applied to the grid 65 and/or the anode electrode 66. However, since the filament power source Ef is an ac source, the negative potential of the filament power source Ef is applied even during a non-luminous time. This causes a leakage of the emitted light so that the anode electrode 66 is not completely turned off. In order to overcome such a problem, the cut-off power source Ek applies a negative potential (a cut-off bias) to the grid 65 via the resistor Rg and the anode electrode 66 via the resistor Rp. The absolute value of the cut-off bias is set to at least a value larger than the maximum amplitude of the filament power source Ef.

FIG. 13 depicts a fluorescent display tube having an octagonal hermetic vessel. Display areas 661, 662, and 663, and the anode substrate 611 are shown as an example.

Referring to FIG. 13(a), the filaments 641 to 648 are stretched between a pair of metal layers 62 and 62 and both the ends thereof are securely to the metal layers 62 and 62, respectively. Because the hermetic vessel is in an octal form, the filaments 641 to 648 are different in length at positions where the filaments 641 to 648 are stretched. In other words, the length of each filament is classified into three types, namely the filaments 641 and 648, the filaments 642 and 647, and the filaments 643 to 646. When the filaments 641 to 648 have the same diameter, the resistance value of each filament depends on the length thereof, thus leading to a different current value or to a different heating temperature. Accordingly, the electron emission amount depends on filaments. The luminous brightness is influenced by the position of an anode electrode, which confronts the corresponding filament. As a result, variations in brightness occur.

In order to eliminate variations in brightness, the filaments may be set to the same resistance value by varying the diameter of the filament according to the length thereof. However, this measure leads to an increased number of filaments of different diameters. In the case shown in FIG. 13(a), filaments of three types are used. The type of filament increases with the number of filaments to be used. Fluorescent display tubes of various sizes or shapes use filaments of various lengths, respectively. Thus, the diameter corresponding to the length of the filament leads to a huge number of types of the filament. It is difficult to store and manage filaments having all types of diameter. The production costs of filaments increase.

Another method may be considered. That is, the filaments 641 to 648 of the same diameter are used. Different filament power sources are used according to the resistance values of filaments, respectively, to uniform the current flowing through each filament. However, this method requires filaments power sources of various types to a single fluorescent display tube, the cost of power source increases.

In view of the above-mentioned problem, a method has been proposed as disclosed in Japanese Patent Laid-open Publication No. Tokkai 2003-51276. That is, plural filaments of the same diameter and different lengths are arranged in parallel and are stretched backwards and forwards via junction terminals, thus being connected serially. By doing so, one long filament is formed equivalently and is adjusted in length. Thus, the resistance value of the filament is adjusted.

FIG. 13(b) shows the example of using the junction terminals, as a variation of the arrangement in FIG. 13(a). The eight filaments 641 to 648, arranged in parallel, are divided into two groups. The filaments 641 to 644 are shuttled twice via the junction metal layers 62R1, 62R2 and 62R3, thus being connected serially as a whole. Both ends of the chain of filaments 641 to 644 are connected to the metal layers 62T1 and 62T2 for cathode wiring, respectively. Similarly, the filaments 645 to 648 are shuttled twice via the junction metal layers 62R4, 62R5 and 62R6, thus being connected serially as a whole. Both ends of the chain of filaments 645 to 648 are connected to the metal layers 62T3 and 62T4 for cathode wiring, respectively.

In this case, because the filaments in each group have the same total length, a common filament power source can be used for the two groups and other power source such as a cutoff power source can be used in common. However, because the filaments of each group are shuttled twice to connect serially them as a whole, the total length becomes four times while the total resistance value becomes four times. Therefore, the filament power source has to be set to an increased voltage to heat each filament at 600° C. to 650° C. Increasing the voltage of the filament power source requires increasing the voltage of the cut-off power source. Moreover, increasing the cut-off voltage results in decreasing the effective value of the grid voltage and the effective value of the anode voltage. In order to prevent a drop of the effective value, the voltage of the anode power source and the voltage of the grid power source must be increased.

In the system shown in FIG. 13(b), filaments are shuttled via the junction terminals to adjust the lengths thereof. This system is applicable to the case where an even number of filaments are prepared or filaments are arranged symmetrically as shown in FIG. 13(b). However, filaments may not be always grouped as shown in FIG. 13(b). A combination of filaments is carried out restrictively. Moreover, because the length or the resistance value of a combined single filament depends on the length of each filament, it cannot be adjusted broadly and finely.

### SUMMARY OF THE INVENTION

The present invention is made to solve the above-mentioned problems.

An object of the present invention is to provide an electron tube, such as a fluorescent display tube, which includes plural filaments of the same diameter but different length. In such an electron tube, the length or the resistance value of electron emissive portions of filaments of the same diameter can be adjusted broadly and finely, without using the junction terminals or the junction metal layers.

Furthermore, an object of the invention is to provide an improved electron tube wherein filaments are serially connected in a controlled resistance value even when the junction terminals or the junction metal layers are used, without using a filament meandered across and parallel as in the conventional manner.

In an aspect of the present invention, the electron tube comprises a plurality of filaments, a pair of wiring conductive layers to which ends of each of the plurality of filaments is connected, respectively, and a short-circuited portion formed on a portion of each of the plurality of filaments.

In another aspect of the present invention, the electron tube comprises a plurality of filaments each having a different length, a pair of wiring conductive layers to which ends of each of the plurality of filaments are connected, respectively, and a short-circuited portion formed on a portion of each of the plurality of filaments, wherein each of the plurality of filaments is set substantially to the same effective length.

In further another aspect of the present invention, the electron tube comprises a plurality of filaments each having a different length, a plurality of equivalent filaments arranged in parallel, each of the plurality of equivalent filaments being formed of the plurality of filaments serially connected via junction conductive layers, and a pair of wiring conductive layers to which ends of each of the plurality of equivalent filaments are connected, respectively. A combination of filaments constructing each equivalent filament sets the effective lengths of the plurality of equivalent filaments to substantially the same value. The spacing for junction is adjusted in such a way that each equivalent filament is settled between the pair of wiring conductive layers.

In the electron tube of the present invention, each of the short-circuited portions comprises a conductive layer for short-circuiting the filament. The junction conductive layer is formed in common to the filaments of two or more. The conductive layer for short-circuiting the filament is formed in common to the filaments of two or more. The position at which at least one end of each filament is connected to the wiring conductive layer depends on the direction where the filament is stretched. The position at which at least one end of each equivalent filament is connected to the wiring conductive layer depends on the direction where the equivalent filament is stretched. The shape of the wiring conductive layer corresponds to the outline of an irregularly-shaped hermetic vessel or of an irregularly-shaped luminous area. The filaments are arranged linearly or polygonally. The spacing of the filaments depends on a luminous area.

### BRIEF DESCRIPTION OF THE DRAWINGS

This and other objects, features, and advantages of the present invention will become more apparent upon a reading of the following detailed description and drawings, in which:

FIG. 1 is a schematic view illustrating a fluorescent display tube according to an embodiment of the present invention;

FIG. 2 is a schematic view illustrating in detail the portion 14P in FIG. 1;

FIG. 3 is a schematic view illustrating in detail the portion 14P in FIG. 1, which is different from the portion shown in FIG. 2;

FIG. 4 is a schematic view illustrating the short-circuited portion in FIG. 1, which is different from the portion shown in FIG. 2;

FIG. 5 is a schematic view illustrating the portion 14P in FIG. 1, which is different from the portions shown in FIGS. 2, 3, and 4;

FIG. 6 is a schematic view illustrating fixing means for an end of a filament and a short-circuited portion thereof, which is different from the fixing means shown in FIGS. 1, 2, and 4;

FIG. 7 is a schematic view illustrating plural filaments arranged in a polygonal shape;

FIG. 8 is a schematic view illustrating a filament arrangement, wherein one group of the filament pieces covers a different range of one of display areas;

FIG. 9 is a schematic view illustrating filaments, each being formed of filament pieces connected serially via junction metal layers;

FIG. 10 is a schematic view illustrating filaments, each being formed of filament pieces connected serially via junction metal layers, one group of the filament pieces covering a different range of one of display areas;

FIG. 11(a) is a cross-sectional view illustrating a conventional fluorescent display tube and FIG. 11(b) is a plan view illustrating the same;

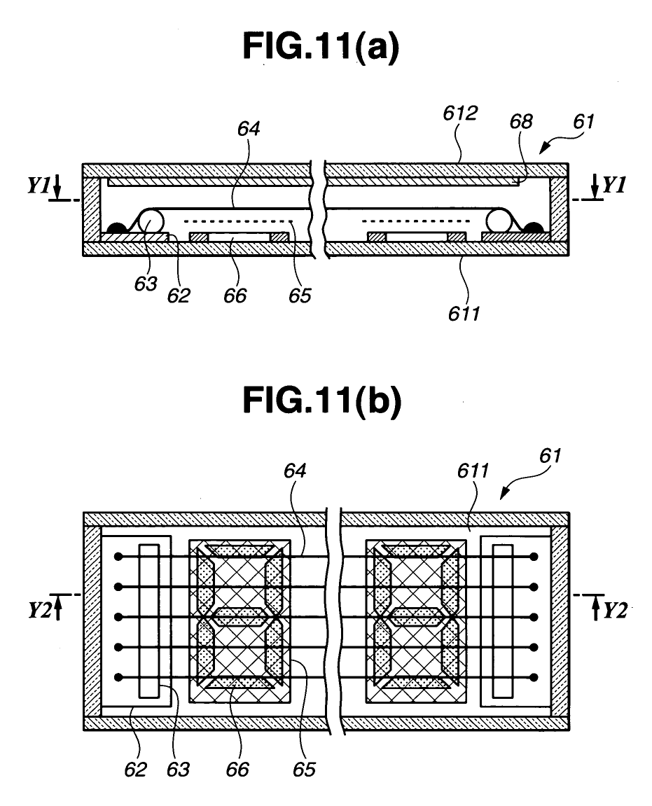

FIG. 12 is a diagram illustrating the outline of the driver circuit for the conventional fluorescent display tube; and

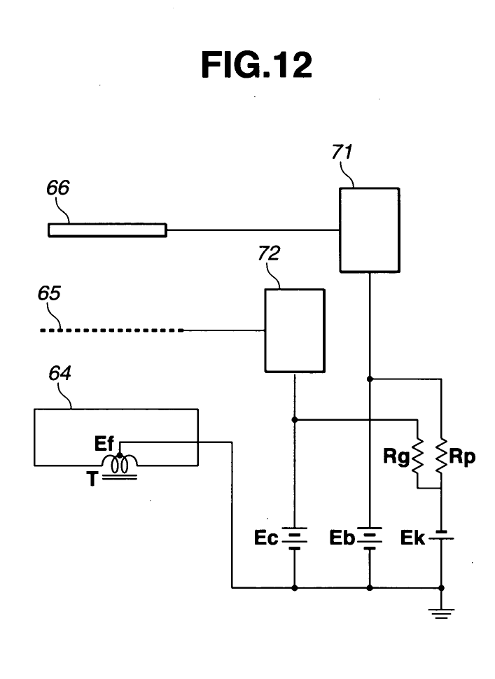

FIG. 13 is a plan view illustrating the conventional display tube having an octagonal vacuum vessel.

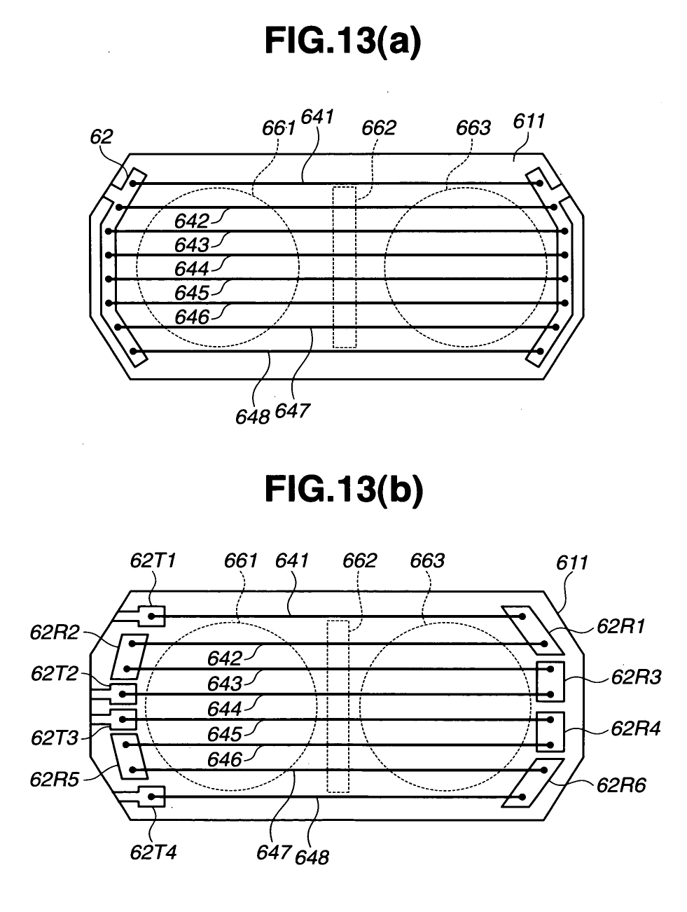

### DESCRIPTION OF THE EMBODIMENTS

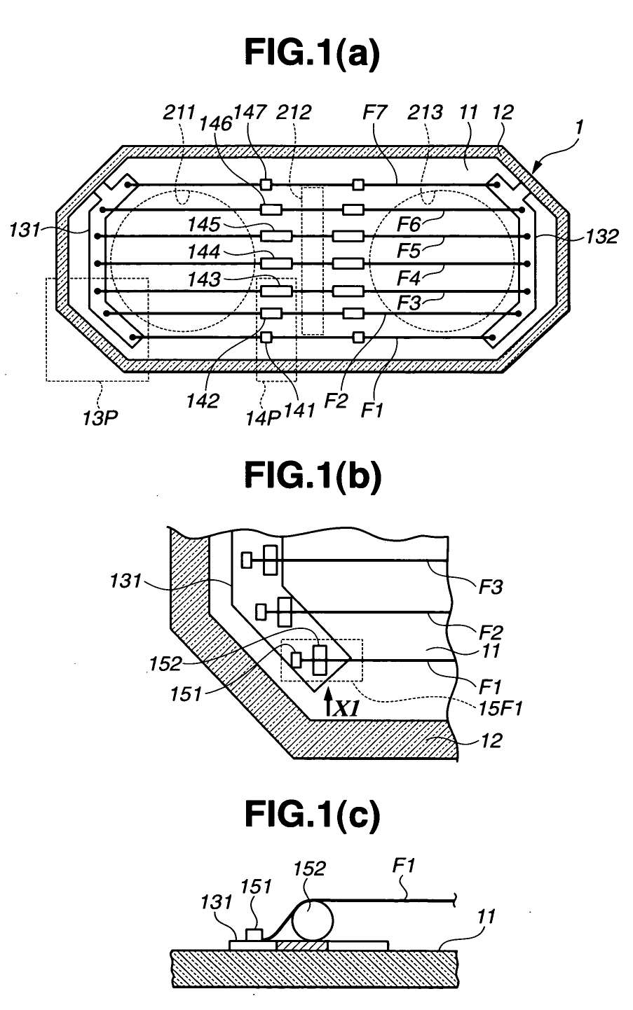

A fluorescent display tube according to an embodiment of the present invention will be described below by referring to FIGS. 1 to 10. Referring to FIGS. 1 to 10, the same numerals are used to designate the common elements. When the same constituent elements exist, the typical constituent element is designated by the reference numeral.

The fluorescent display tube of the embodiment will be described below in detail by referring to FIG. 1.

FIG. 1 is a diagram illustrating an octal fluorescent display tube according to an embodiment of the present invention. FIG. 1(a) is a plan view illustrating the whole cross section of a fluorescent display tube. FIG. 1(b) is an enlarged fragmental plan view illustrating the portion 13P in FIG. 1(a). FIG. 1(c) is a cross-sectional view illustrating the portion 15F1 in FIG. 1(b), enlarged in the arrow direction X1.

Referring to FIG. 1(a), numeral 11 represents an anode substrate formed of an insulating material such as glass and numeral 12 represents a side plate formed of an insulating material such as glass. The anode substrate 11 and the side plate 12 form part of the hermetic vessel similar to the conventional fluorescent display tube. The side plate 12 may be formed of a beaded fritted glass, instead of glass. A pair of metal layers (wiring conductive layers) 131 and 132 for cathode wiring, made of a metal thin film, are formed according to the form of the hermetic vessel 1 and/or the form of a display or luminous area corresponding to the form of an node pattern. Cathode filaments F1 to F7 are stretched in parallel and the ends thereof are bonded to the metal layers 131 and 132, respectively. Among the filaments F1 and F7, the filaments F2 and f6; and the filaments F3, F4 and F5, the location where a filament is fixed in the stretch direction is different. Numerals 141 to 147 represent the short circuit portions of the filaments F1 to F7, respectively. The display areas 211, 212, and 213 have a predetermined shape. The display areas 211 and 213 are circular or oval not rectangular in shape, although the central display area 212 is rectangular. The shape of each display area is determined by the shape of an anode electrode constituting a display portion or by the arrangement pattern of anode electrodes.

The short circuit portions 141 to 147 are formed in the dead spaces adjacent to the sides of the display area 212 between the two display areas.

The octagonal display tube shown in FIG. 1, for example, is used on the dashboard in a car. The display area 211 provides a speedometer. The display area 212 provides a position indicator. The display area 213 provides a tachometer.

The filaments F1 to F7 have the same diameter but have different lengths, respectively. That is, the filaments F1 to F7, the filaments F2 and F6, and the filaments F1 and F7 have three different lengths, respectively. As to each of the filaments F1 to F7, its different length results in a different resistance value. Therefore, when the same filament voltage is applied to the filaments F1 to F7, different currents flow through the filaments F1 to F7, respectively, because the resistance values thereof are different. The different currents cause different heating temperatures so that the electrons are emitted differently in amount. As a result, in the display areas 211, 212, and 213, the luminous brightness is different between the portions confronting the filaments F1 to F7, so that variations in brightness occur.

In the present embodiment, the ends of the filaments F1 to F7 have one ends bonded to the metal layer 131 and the other ends bonded to the metal layer 132. Short circuited portions 141 to 147, which short-circuits filaments, are formed on the intermediate portions of the filaments fixed, respectively. The resistance value of each of the short-circuited portions 141 to 147 is smaller than that of each of the filaments F1 to F7. The short-circuited portions 141 to 147 are formed of, for example, aluminum which is two digits smaller than the resistance value of the filament. As to the filaments F1 to F7, since the current is bypassed, the short-circuited portion does not emit electrons. Accordingly, when the total length of the portions of the filaments F1 to F7, through which current flows, namely the total length of portions not short-circuited is equalized, the length of the portions contributing to electron emission (hereinafter referred to as an effective length of a filament) is shorter than the actual length by the total length of the portions which is short-circuited by the length of the short-circuited portions 141 to 147 formed on both the sides of the display area 212 (hereinafter referred to as a short circuit length of the short circuited portion). The short circuit length of each of the short-circuited portions 141 to 147 is determined by the distance between filament fixing metal pieces to be described later or by the length of a spacer to be described later when the spacer is made of a conductive material.

The short-circuited portions 143, 144 and 145 respectively corresponding to the filaments F3, F4 and F5 have a maximum length. The short-circuited portions 142 and 146 respectively corresponding to the filaments F2 and F6 have an intermediate length. The short-circuited portions 141 and 147 respectively corresponding to the filaments F1 and F7 have a minimum length. When the lengths of the short-circuited portions 141 to 147 are set corresponding to the lengths of the filaments, the effective lengths of the filaments F1 to F7 are set nearly to the same value. Moreover, the resistance values, currents, and temperatures of the filaments F1 to F7 are set nearly at the same value, preferably within a range of ±several %. It is not always required to form the short-circuited portion 141 and 147 of the shortest filament F1 and F7. The short-circuited portions 142 to 146 may be set in such a way that the effective lengths of the filaments F2 to F6 are equalized with the lengths of the filaments F1 and F7.

According to the present embodiment, the effective length of each filament is adjusted by adjusting the lengths of the short-circuited portions of the filaments F1 to F7. Hence, compared with the conventional case where the filaments, each of which has a different length, are serially connected with the junction terminals, the effective length of each filament of the present invention can be adjusted easily and finely. Therefore, the effective length of each filament can be adjusted finely in a broad range. Moreover, in the present embodiment, since plural filaments are serially connected, the resistance value of each filament does not increase by adjusting the effective length of each filament.

Next, the example where one end of each filament is securely anchored to the metal layer 131 will be explained below with reference to FIGS. 1(b) and 1(c).

The end of the filament F1 is bonded to the metal layer 131 by way of ultrasonic, together with the metal piece 151. During this process, the filament F1 is sustained in a predetermined level with the spacer 152, which is bonded previously to the metal layer 131 by way of ultrasonic. Similarly, the filaments F2 and F3 are bonded to the metal layer 131. Diffusion bonding or friction bonding corresponding to ultrasonic bonding or ultrasonic wire bonding or solid-sate bonding corresponding to ultrasonic pressure are included as the ultrasonic bonding. When one end of the filament F1 is securely anchored, carbonate as an electron emission material, coated on the surface of the filament F1, is removed in advance through laser irradiation, but it may not be removed as a matter of practice.

A tension adder such as a coil is formed to the whole or part of the filament F1 to provide a predetermined amount of tension.

The metal piece 15 and the spacer 152 are formed respectively. However, the metal piece 151 and the spacer 152 may be formed integrally as one-piece component.

The filament fixing/holding method of the present embodiment should not be limited only to the method of using the metal piece 151 and the spacer 152, shown in FIGS. 1(b) and 1(c), to fix filaments securely. Conventional filament support members, such as metal-processed anchors or supports, may be used generally.

In the present embodiment, the filament is not cut at the short-circuited portion. As a result, the number of filament cutting steps, the production cost, and wastes such as carbonate produced by cutting can be reduced.

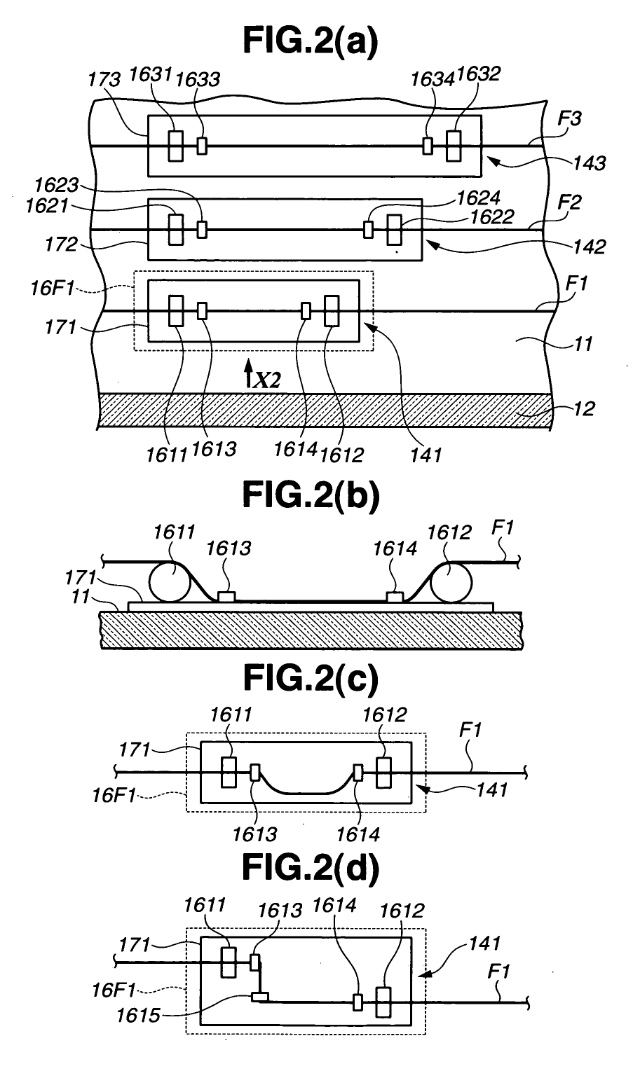

FIG. 2 shows in detail a short-circuited portion of each filament in FIG. 1(a). FIG. 2(a) is an enlarged view illustrating the portion 14P in FIG. 1(a). FIG. 2(b) is an enlarged cross-sectional view illustrating the portion 16F1 taken in the arrow direction X2. FIG. 2(c) shows a variation of the portion 16F1 of FIG. 2(a) and FIG. 2(d) shows a variation of the portion 16F1 of FIG. 2(a).

The embodiment will be explained with reference to FIGS. 2(a) and 2(b).

Conductive metal layers 171 to 173 such as metal thin films for partially short-circuiting filaments are formed on the anode substrate 11. The filament F1 is bonded partially to the metal layer 171 by way of ultrasonic, together with the metal piece 1613, 1614. The filament F1 is maintained in a predetermined level by means of the spacers 1611 and 1612. Similarly, the filament F2 is bonded partially to the metal pieces 1623 and 1624 and is maintained in a predetermined level by means of the spacers 1621 and 1622. The filament F3 is bonded partially to the metal pieces 1633 and 1634 and is maintained in a predetermined level by means of the spacers 1631 and 1632.

The filament F1 is short-circuited partially by the metal pieces 1613 and 1614 and the metal layer 171. The length of the short-circuited portion 141 is determined based on the distance or spacing between the metal pieces 1613 and 1614. When a conductive material such as metal is used for the spacer 1611, 1612, the length of the short-circuited portion 141 is determined the distance between the spacers 1611 and 1612. This is applicable to the filaments F2 and F3.

Referring to FIG. 2(c), the filament F1 is stretched linearly between the metal pieces 1613 and 1614, but may be slackened as shown in FIG. 2(c). In the filament F1, the portion of the filament F1 between the metal pieces 1613 and 1614 is short-circuited by means of the metal layer 171. The resistance value between the metal pieces 1613 and 1614 is determined by the resistance value of the metal layer 171 and is constant irrespective of the length of the filament between the metal pieces 1613 and 1614. This is applicable to the filaments F2 and F3.

In the case shown in FIG. 2(c), the filaments, which are cut to the same length, can be used. For example, the filament F1 may be slackened larger than the filament F2 and the filament F2 may be slackened larger than the filament F3. By doing so, the filaments F1, F2 and F3, which are cut to the same length, can be used. Accordingly, it is not required to prepare filaments having different lengths, for example three different lengths in the case shown FIG. 1, to match the filaments with the stretching positions. This facilitates the filament cutting work. Moreover, when the filament is stretched, it is not required to select filaments of the lengths matching the stretching positions. Accordingly, the filament stretching work can be facilitated.

Next, the embodiment will be explained below with reference to FIG. 2(d).

In the filament F1 shown in FIG. 2(a), the axis line in the stretching direction of the portion bonded to the metal piece 1613 is matched to the axis line in the stretching direction of the portion bonded to the metal piece 1614. However, in the case of FIG. 2(d), the axis lines in the stretching direction are offset from each other. Both the ends of the filament F1 are offset in the axis line but have the same stretching direction. As a whole, the filament F1 is installed linearly and in the same direction. In other words, the filament F1 is directed from the metal piece 1613 to the metal piece 1615 and is fixed to the metal layer 171 with the metal piece 1615. Moreover, the filament F1 is directed from the metal piece 1615 to the metal piece 1614 and is fixed to the metal layer 171 with the metal piece 1614. This step is applicable to the filaments F2 and F3. In that case, the filament F1 may be directly stretched between the metal pieces 1613 and 1614, with the metal piece 1615 omitted.

In the example shown in FIG. 2(d), even when the display areas, arranged on both sides of the short-circuited portion 141, are disposed in offset state, the shifted state can be dealt with one filament F1.

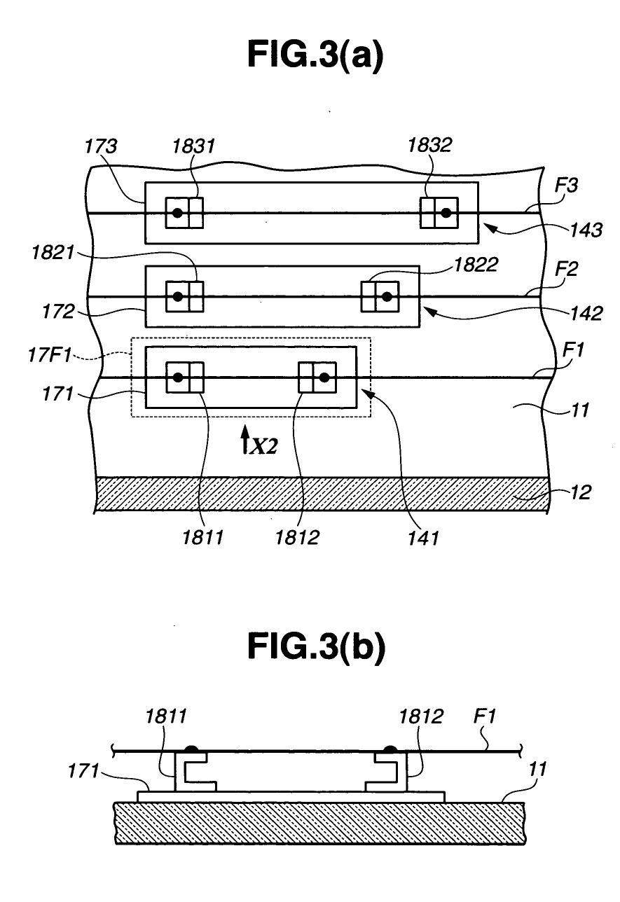

FIG. 3 shows in detail the portion 14P of FIG. 1(a) and illustrates a configuration other than the short-circuited portion of FIG. 2. FIG. 3(b) is an enlarged cross-sectional view illustrating the portion 17F1 taken in the arrow direction X2 of FIG. 3(a).

Filament supports 1811 and 1812, metal-processed, are bonded to the metal layer 171. Filament supports 1821 and 1822, metal-processed, are bonded to the metal layer 172. Filament supports 1831 and 1832, metal-processed, are bonded to the metal layer 173. The filament F1 is welded to the filament support portion 1811 and 1812. The filament F2 is welded to the filament support portion 1821 and 1822. The filament F3 is welded to the filament support portion 1831 and 1832.

The length of the short-circuited portion 141 of the filament F1 depends on the distance between the filament supports 1811 and 1812. This is applicable to the short-circuited portion 142 of the filaments F2 and the short-circuited portion 142 of the filaments F3.

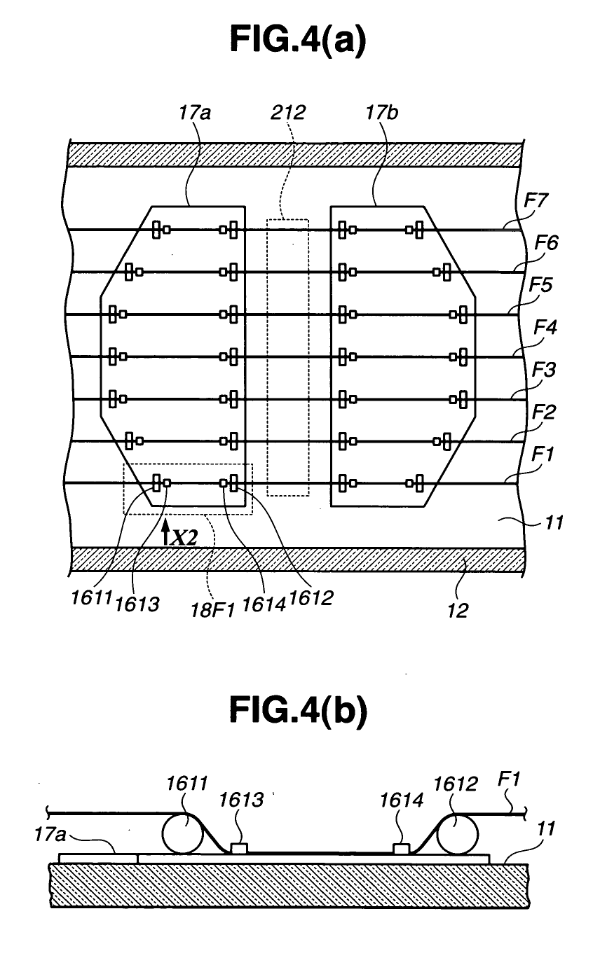

FIG. 4 illustrates the structure of the short-circuited portions of the filaments in FIG. 1(a) and differs from the configuration of the metal layer forming each short-circuited portion shown in FIG. 2. The configuration of portions other than the metal layers resembles that shown in FIG. 2. FIG. 4(a) is a plan view illustrating the whole of the short-circuited portions. FIG. 4(b) is an enlarged cross-sectional view illustrating the portion 18F1 of FIG. 4(a), taken in the arrow direction X2.

Conductive metal layers 17a and 17b are formed in a spread state, without being formed respectively for the filaments F1 to F7. The filament F1 is sustained in a predetermined level by means of the spacers 1611 and 1612. The filament F1 is partially bonded to the metal layer 17a by way of ultrasonic, together with the metal pieces 1613 and 1614. The metal layer 17b is formed in a manner similar to that explained hereinabove. Also, the filaments F2 to F7 are installed in a manner similar to that explained hereinabove.

The length of the short-circuited portion of the filament F1 depends on the distance between the metal pieces 1613 and 1614. When the spacer 1611, 1612 is formed of a conductive material, the length of the short-circuited portion is determined by the distance between the spacers 1611 and 1612. This is applicable to the filaments F2 to F7.

In the filaments F1 to F7 stretched above the display area 212 shown in FIG. 4, the effective length of the non-short-circuited portion between the metal layers 17a and 17b is set to the same value. By equalizing the non-short-circuited portions to the same length, each filament between the metal layers 17a and 17b has the same resistance value, thus passing the same current. Referring to FIG. 4(a), the outline of the left side of the metal layer 17a is similar to that of the metal layer 131 of FIG. 1 and the outline of the right side of the metal layer 17b is similar to that of the metal layer 132 of FIG. 1. In this manner, the effective lengths of the filaments F1 to F7 stretched over the display areas 211 and 213 shown in FIG. 1, can be equalized.

In order to anchor the filament F1 securely, the metal-processed filament support 1811, 1812 shown in FIG. 3 may be used instead of the metal pieces 1613 and 1614 and the spacers 1611 and 1612. This is applicable to the filaments F2 to F7.

Referring to FIG. 4, the metal layers 17a and 17b, which are formed in a spread state, are shared by two or more filaments. Therefore, the metal layers 17a and 17b can be easily formed.

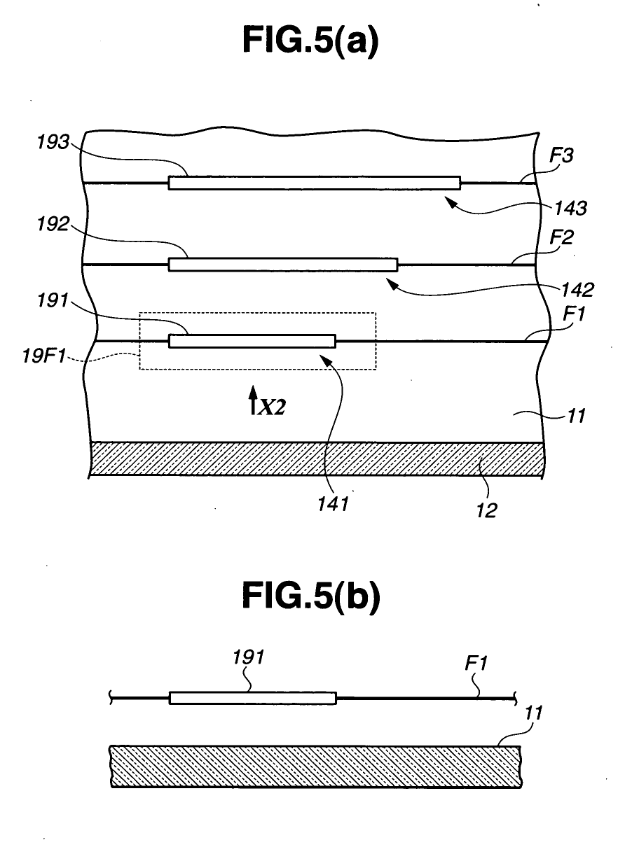

FIG. 5 shows in detail the portion 14P of FIG. 1(a) and shows a structure different from the short-circuited portions in FIGS. 2, 3 and 4. FIG. 5(b) is a cross-sectional view illustrating the portion 19F1 of FIG. 5(a) taken in the arrow direction X2.

The filament F1 is short-circuited partially by means of the short-circuited portion 191 formed on or attached to the filament F1. The filament F2 is short-circuited partially by means of the short-circuited portion 192 formed on or attached to the filament F2. The filament F3 is short-circuited partially by means of the short-circuited portion 193 formed on or attached to the filament F3. The short-circuited portion 191 may be formed partially by depositing a metal layer onto the filament F1 or by attaching a metal piece. The short-circuited portion 192 may be formed partially by depositing a metal layer to the filament F2 or by attaching a metal piece. The short-circuited portion 193 may be formed partially by depositing a metal layer to the filament F3 or by attaching a metal piece.

The length of the short-circuited portion 141 of the filament F1 depends on the length of the short-circuited member 191. The length of the short-circuited portion 142 of the filament F2 depends on the length of the short-circuited member 192. The length of the short-circuited portion 143 of the filament F3 depends on the length of the short-circuited member 193.

In the structure shown in FIG. 5, metal pieces, spacers, or filament supports, each of which fixes and holds a filament, and metal layers for anchoring them, as shown in FIGS. 2, 3 and 4, are not required. Accordingly, the structure of the short-circuited portion is simplified and the short-circuited portion can be easily formed. Moreover, because the metal layer for anchoring the filament fixing and holding member is not formed on the anode substrate 11, the display area can be easily formed on the anode substrate 11 and the anode substrate can be effectively utilized.

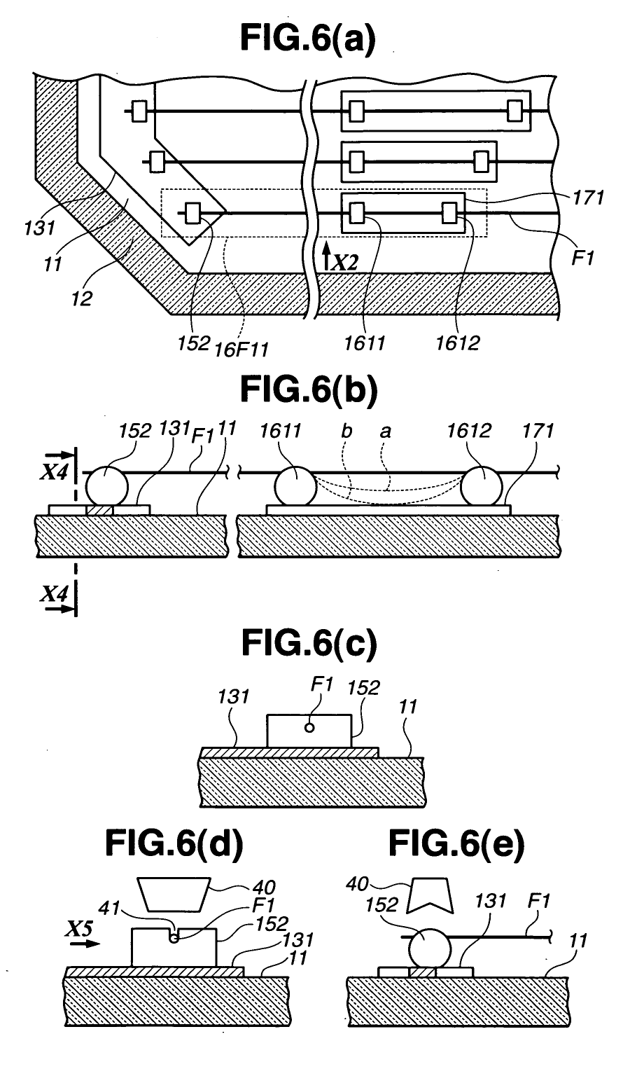

FIG. 6 shows as an example the structure in which the fixing means for the ends and the short-circuited portion of a filament are different from the fixing means shown in FIGS. 1, 2 and 4. FIG. 6(b) is an enlarged cross-sectional view illustrating the portion 16F11 taken in the arrow direction X2 in FIG. 6(a). FIG. 6(c) is a side view illustrating the portion taken in the arrow direction X4 in FIG. 6. FIG. 6(d) is a view illustrating the steps of fixing filaments. FIG. 6(e) is a side view illustrating the steps of fixing filaments and the portion taken in the arrow direction X5 of FIG. 6(d).

Using a filament fixing member of the same type, the end of a filament is fixed to the metal layer 131 and the short-circuited portion thereof is fixed to the metal layer 171.

The filament F1 is bonded directly to the spacer 152 securely fixed on the metal layer 131 and to the spacers 1611 and 1612 securely fixed on the metal layer 171 by way of ultrasonic. Accordingly, the same spacer 152 for fixing the filament F1 to the metal layer 131 and the spacer 1611, 1612 for sustaining the filament F1 in a predetermined level can be used.

Next, the steps of fixing the filament F1 will be explained below with the spacer 152 shown as an example.

The spacer 152, as shown in FIG. 6(d), has the groove 41 formed perpendicularly to the elongate direction thereof. The filament F1 is inserted into the groove 41. The spacer 152 is pressed with the ultrasonic bonding tool 40 to close the groove 41. Thus, the filament F1 is bonded to the spacer 152, as shown in FIG. 6(c).

In this process, the groove 41 is not always needed. However, formation of the groove 41 facilitates positioning of the filament F1 or setting of an elevated level of the filament F1. Moreover, the spacer 152 may be arranged along the elongate direction where the filament F1 is stretched, without being arranged perpendicularly to the filament F1.

In the structure of FIG. 6, members of the same type can be used as the spacer and the fixing member for the filament. Therefore, this facilitates to reduce the number of components and the number of mounting steps. Moreover, the space for fixing filaments can be decreased.

As shown with the broken lines a and b in FIG. 6(b), the filament F1 may be slackened between the spacers 1611 and 1612.

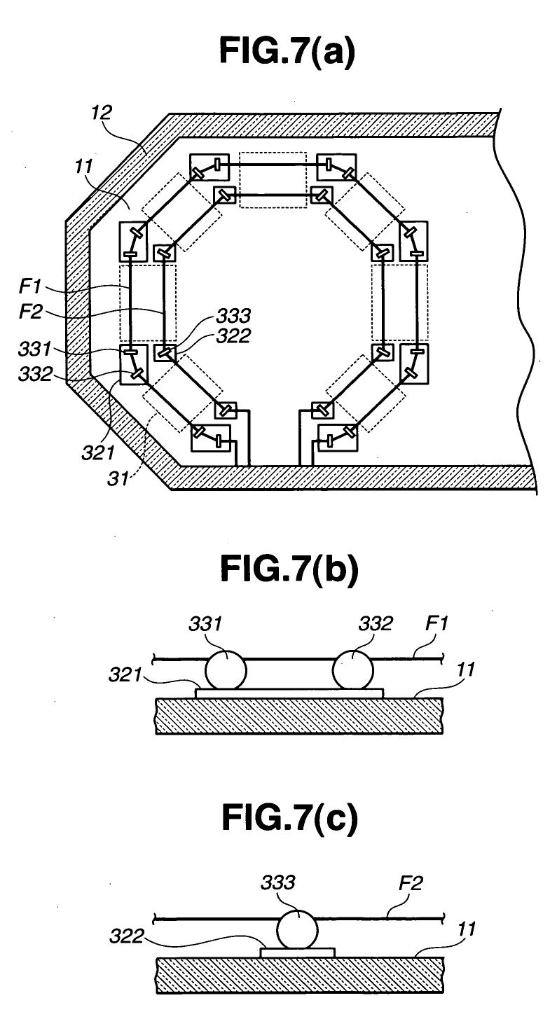

FIG. 7 shows plural filaments arranged in a polygonal shape.

FIG. 7(a) is a plan view illustrating an arrangement of plural filaments. FIG. 7(b) is an enlarged longitudinal cross sectional view illustrating a filament fixing portion. FIG. 7(c) is an enlarged longitudinal cross sectional view illustrating a filament fixing portion.

The filaments F1 and f2 are arranged in parallel and in an octagonal form. At each corner, conductive metal layers 321 and 322 are disposed. Spacers 331 and 332 are securely fixed to the metal layer 321. A spacer 333 is securely fixed to the metal layer 322. A display area 31 is formed between the metal layers 321 and 322 and metal layers 321 and 322. The filament F1 disposed outside the filament F2 becomes longer than the filament F2. For that reason, in order to equalize the effective lengths of the filaments F1 and F2, shown in FIG. 7, the spacers 331 and 332 are securely fixed to the metal layer 321. The length of the short-circuited portion of the filament F1 is adjusted by adjusting the distance between the spacers 331 and 332.

The arrangement of the filaments F1 and F2 should not be limited only to an octagonal form. It may be a different form. Moreover, the number of filaments is not limited to only two.

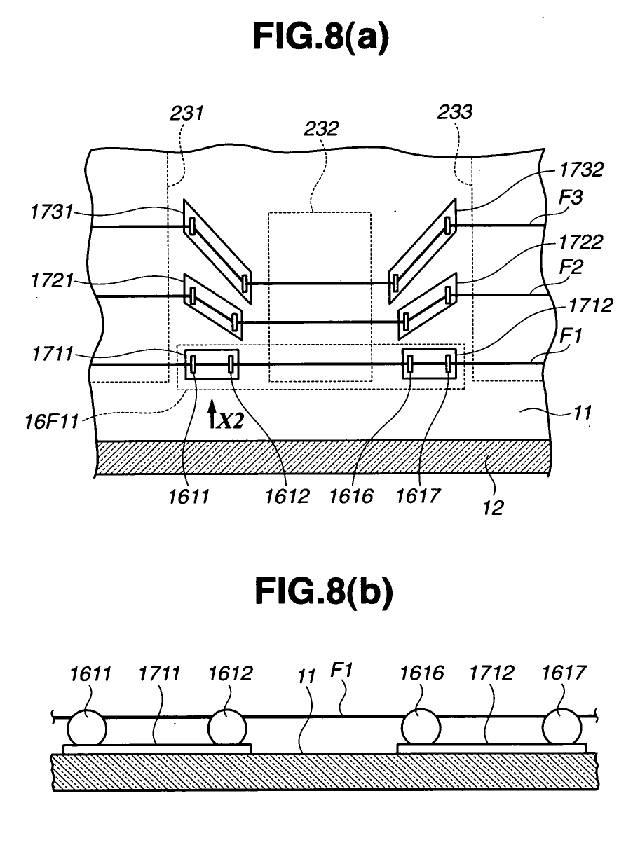

FIG. 8 shows a filament arrangement in the case where plural display areas exist and the size of the display area covered by the filaments is different.

FIG. 8(a) is a plan view illustrating an arrangement of filaments. FIG. 8(b) is an enlarged cross sectional view illustrating the portion 16F11 taken in the arrow direction X2 of FIG. 8(a).

Each of the display areas 231, 232 and 233 is formed of, for example, 5×8 segments. When the segmented dot size of the display area 231 and 233 is larger than that of the display area 232, some of the filaments cannot cover the display area 232.

Referring to FIG. 8, the spacing between the filaments F1, F2 and F3 changes to a certain display area. In the display area 231 and 233, the filaments are disposed to be larger spacing than the display area 232. The filaments F1, F2, and F3 are deflected at the conductive metal layers 1711 and 1712, the conductive metal layers 1721 and 1722, and the conductive metal layers 1731 and 1732, respectively. The spacing between the filaments F1, F2 and F3 is narrowed over the display area 232. In the filaments F1, F2 and f3, the filament F1 is bonded on the spacers 1611 and 1612, each acting as a fixing member, overlying the metal layer 1711 and on the spacers 1616 and 1617, each acting as a fixing member, overlying the metal layer 1712. The length of the short-circuited portion of each filament is adjusted according to the distance between spacers. The filaments F2 and F3 are bonded to the spaces in the same manner as the filament F1.

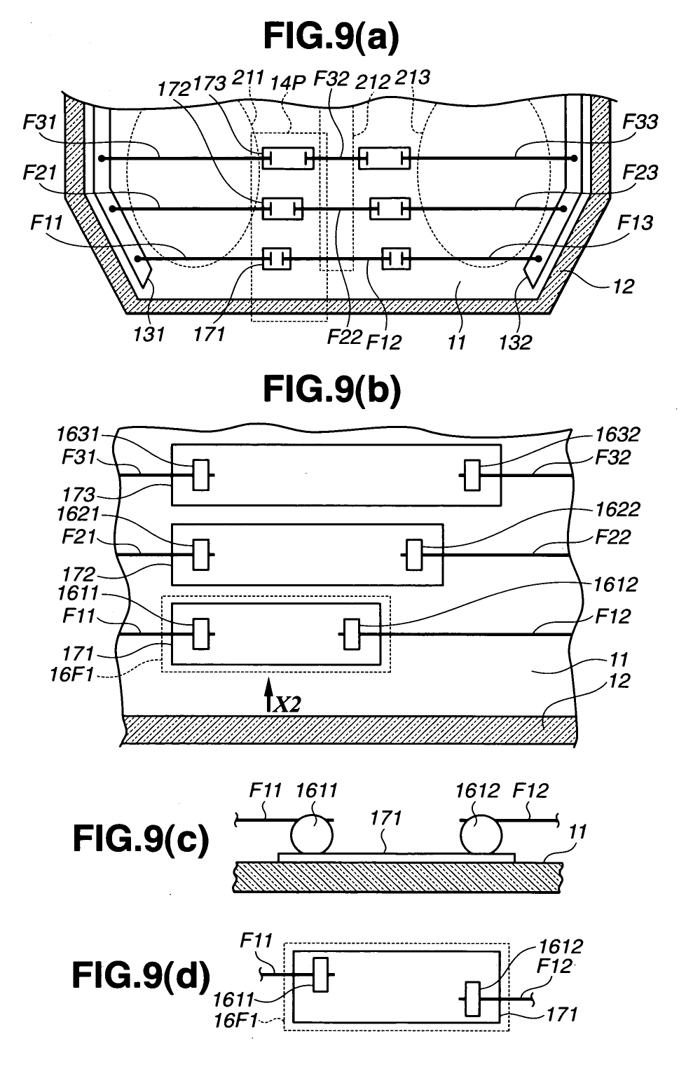

FIG. 9 shows the example of adjusting the resistance value of a filament by serially connecting filament segments via junction metal layers.

FIG. 9(a) is a plan view illustrating a filament arrangement. FIG. 9(b) is an enlarged cross sectional view illustrating the portion 14P of FIG. 9(a). FIG. 9(c) is an enlarged cross sectional view illustrating the portion 16F1 taken in the arrow direction X2. FIG. 9(d) is a view illustrating a modification of the portion 16F1 in FIG. 9(b).

Referring to FIG. 9(a), three equivalent filaments are stretched between the conductive metal layer 131 and the conductive metal layer 132. Each equivalent filament is formed of three filament segments, which are serially connected via junction conductive metal layers. For example, the equivalent filament, formed of the filaments F11, F12 and F13, is formed as a single filament via two junction metal layers 171. The equivalent filament has one end fixed to the metal layer 131 and the other end fixed to the metal layer 132. This structure is applicable to other equivalent terminals.

In the junction portion as shown in FIGS. 9(b) and 9(c), one end of the filament F11 is bonded to the spacer 1611 acting as a fixing member as well attached to the metal layer 171. One end of the filament F12 is bonded to the spacer 1612 acting as a fixing member as well attached to the metal layer 171. This structure is applicable to other filaments.

As to the filaments F11, F12 and F13, the filaments F21, F22, and F23, and the filaments F31, F32, and F33, each group is formed of a combination of filaments of different lengths. The total length of the filaments F11, F12, and F13, the total length of the filaments F21, F22, and F23, and the total length of the filaments F31, F32, an F33 are respectively set so as to have nearly the same value. As shown in FIG. 9(b), the spacing between the spacers 1611 and 1612, between the spacers 1621 and 1622, and between the spacers 1631 and 1632, namely, the spacing between filaments for junction is changed according to the length of each filament. Thus, the setting is made in such a way that the filament is settled between the metal layers 131 and 132. In this manner, the effective lengths of three effective filaments are set substantially to the same value.

Referring to FIG. 9(d), the filament F11 and F12 are disposed in such a manner that the axis lines thereof are offset. When the size and shape of the display area covered by the filaments F11 and the size and shape of the display area covered by the filament F12 are different, adjustment can be made by offsetting the axis line of the filament F11 and the axis line of the filament F12.

In the case shown in FIG. 9, it is unnecessary to connect serially filaments by shuttling them between the metal layers 131 and 132, as shown in the prior art. Therefore, the serial resistance value does not increase even when plural filaments are serially connected.

The connection scheme for disposing the junction metal layers shown in FIG. 9 is applicable to the embodiments which provide the short-circuited portions shown in FIGS. 1 to 8.

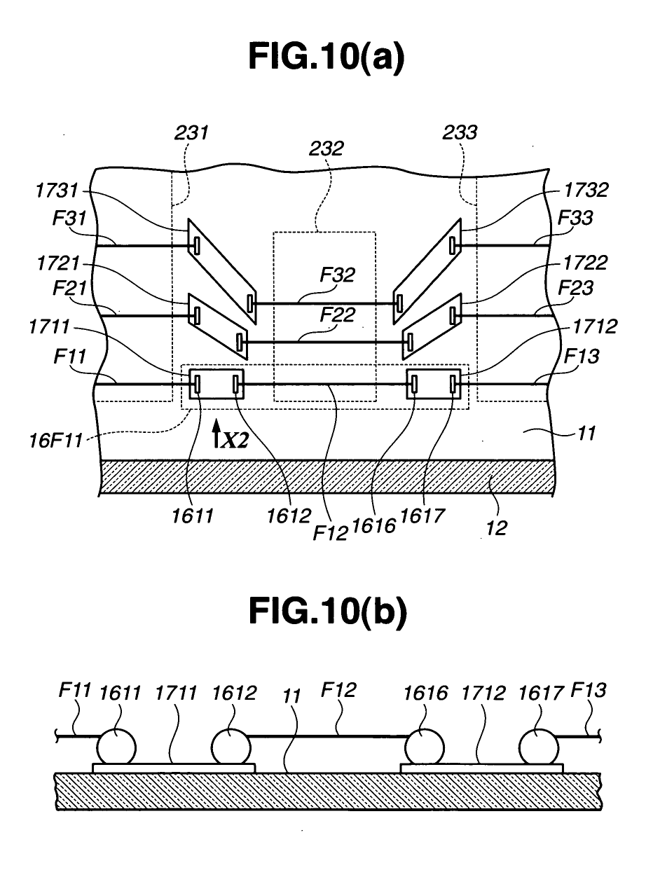

FIG. 10 shows an example where the resistance value of a filament is adjusted by serially connecting filament segments via junction metal layers when plural display areas exist and the size of a display area covered by filament segments is different.

FIG. 10(a) is a plan view illustrating the portion 16F11. FIG. 10(b) is a cross-sectional view illustrating the portion 16F11 taken in the arrow direction X2.

Each of the display areas 231, 232 and 233 is formed of, for example, 5×7 segments. When the segmented dot size of the display area 231 and 233 is larger than the of the display area 232, some of the filaments do not cover the display area 232.

In order to deal with such a problem, the spacing between the filaments F11, F21, and F31 and the spacing between the filaments F13, F23, and F33 are equalized as shown in FIG. 10. The spacing is set to be larger than the spacing between the filaments F12, F22, and F32. In this case, the filaments F11, F12 and F13 are serially connected via the junction metal layers 1711 and 1712 to construct a single equivalent filament. This structure is applicable to other filaments.

In the above embodiments, the example of filaments stretched above the anode substrate has been explained. However, the filaments may be mounted on the front substrate. Similarly, the substrate on which the short-circuited portions are mounted or formed may be the filament mounting substrate or other substrate. The example of plural short-circuited portions formed on the intermediate portion of a filament between cathode wiring metal layers on both ends of a filament has been explained. However, a single short-circuited portion may be mounted according to arrangement of the display area. The number of short-circuited portions depends on the filament configuration. The hermetic vessel should not be limited only to a polygonal vessel such as an octagonal vessel but may have a curved shape, such as a circular form, an elliptic shape, or other irregular shapes including a combination of these shapes. The arrangement and the display content of the display area are not limited to speedometers, tachometers, and others arranged in a dashboard in cars.

The fluorescent display tube has been explained as an example in the above-mentioned embodiments. However, the present invention is applicable to filament built-in electron tubes such as flat-type cathode-ray tubes, fluorescent luminous tubes for printers, and others. Moreover, the example using aluminum in the short-circuited portions has been explained. However, a metal selected from the group constituting of Al, Cu, Ag, Au, Pt, Nb, V, and Ni, or alloys thereof may be used in the short-circuited portions. These materials may be applicable to the metal layers, fixing members, fixing metal pieces, spacers, or short-circuited members.

According to the present invention, the effective length of the filament can be adjusted by varying the length of the short-circuited portion of the filament. Thus, the effective length of the filament can be easily and finely adjusted. Therefore, the effective length of the filament can be adjusted in a broad range. Further, the effective length of the filament can be adjusted without directly connecting plural filaments. Therefore, adjustment of the effective length does not cause an increase of the resistance value of the filament.

According to the present invention, the effective length of the filament can be adjusted by varying the length of the short-circuited portion of the filament. Moreover, by adjusting the effective length of the filament, the resistance values of filaments of the same diameter and different length can be adjusted substantially to the same value. Therefore, even when an electron tube includes plural filaments of different length, a single filament power source can be used as a common power source. The conventional filament configuration, where plural filament segments are zigzagged and directly connected, causes the resistance value of the filament to increase. However, the present invention does not cause the resistance value of the filament to increase. Therefore, it is not required to increase the cut-off bias voltage. The effective value of the anode voltage and the effective value of the grid voltage are not dropped. Therefore, even when an electron tube includes plural filaments of different lengths, the cost of power sources becomes inexpensive.

According to the present invention, even when the junction metal layers are used, the effective lengths of plural equivalent filaments can be equalized through a combination of filaments. That is, in the filament combination, plural filaments are directly connected via junction metal layers to construct a single equivalent filament. Plural equivalent filaments are arranged in parallel. By adjusting the spacing for junction, each equivalent filament can be adjusted to the length within which the equivalent filament is settled between conductive metal layers for cathode wiring, to which both ends of the equivalent filament are bonded. Therefore, even when the junction metal layer is used, a power source shared by plural equivalent filaments can be used. In the conventional manner, since plural filament segments are serially connected through zigzagging, the resistance value of the filament increases. However, according to the present invention, since the resistance value of the filament does not increase, boosting the cut-off bias voltage is not required.

Obviously, many modifications and variations of the present invention are possible in the light of the above teachings. It is therefore to be understood that within the scope of the appended claims, the invention may be practiced otherwise than as specifically described.

1. An electron tube comprising:
a plurality of filaments;
a pair of wiring conductive layers to which ends of each of said plurality of filaments is connected, respectively; and
a short-circuited portion formed on a portion of each of said plurality of filaments.

2. An electron tube comprising:
a plurality of filaments each having a different length;
a pair of wiring conductive layers to which ends of each of said plurality of filaments are connected, respectively; and
a short-circuited portion formed on a portion of each of said plurality of filaments, each of said plurality of filaments being set substantially to the same effective length.

3. An electron tube comprising:
a plurality of filaments each having a different length;
a plurality of equivalent filaments arranged in parallel;
each of said plurality of equivalent filaments being formed of said plurality of filaments serially connected via junction conductive layers; and
a pair of wiring conductive layers to which ends of each of said plurality of equivalent filaments are connected, respectively;
wherein a combination of filaments constructing each equivalent filament sets the effective lengths of said plurality of equivalent filaments to substantially the same value, and the spacing for junction is adjusted in such a way that each equivalent filament is settled between said pair of wiring conductive layers.

4. The electron tube as defined in claim 1, wherein each of said short-circuited portions comprises a conductive layer for short-circuiting the filament.

5. The electron tube as defined in claim 3, wherein said junction conductive layer is formed in common to said filaments of two or more.

6. The electron tube as defined in claim 4, wherein said conductive layer for short-circuiting the filament is formed in common to said filaments of two or more.

7. The electron tube as defined in claim 1, wherein the position at which at least one end of each filament is connected to said wiring conductive layer depends on the direction where said filament is stretched.

8. The electron tube as defined in claim 3, wherein the position at which at least one end of each equivalent filament is connected to said wiring conductive layer depends on the direction where said equivalent filament is stretched.

9. The electron tube as defined in claim 1, wherein the shape of said wiring conductive layer corresponds to the outline of an irregularly-shaped hermetic vessel or of an irregularly-shaped luminous area.

10. The electron tube as defined in claim 1, wherein said filaments are arranged linearly or polygonally.

11. The electron tube as defined in claim 1, wherein the spacing of said filaments depends on an luminous area.

12. The electron tube as defined in claim 2, wherein the position at which at least one end of each filament is connected to said wiring conductive layer depends on the direction where said filament is stretched.

13. The electron tube as defined in claim 2, wherein the shape of said wiring conductive layer corresponds to the outline of an irregularly-shaped hermetic vessel or of an irregularly-shaped luminous area.

14. The electron tube as defined in claim 3, wherein the shape of said wiring conductive layer corresponds to the outline of an irregularly-shaped hermetic vessel or of an irregularly-shaped luminous area.

15. The electron tube as defined in claim 2, wherein said filaments are arranged linearly or polygonally.

16. The electron tube as defined in claim 3, wherein said filaments are arranged linearly or polygonally.

17. The electron tube as defined in claim 2, wherein the spacing of said filaments depends on an luminous area.

18. The electron tube as defined in claim 3, wherein the spacing of said filaments depends on an luminous area.
